(19) United States
(12) Patent Application Publication
(10) Pub. No.: US 2024/0111585 A1
(43) Pub. Date: Apr. 4, 2024

(54) SHARED RESOURCE MANAGEMENT SYSTEM AND METHOD

(71) Applicant: Seegrid Corporation, Pittsburgh, PA (US)

(72) Inventors: Nicholas Alan Melchior, Pittsburgh, PA (US); Benjamin George Schmidt, Wexford, PA (US); Andrew Dempsey Tracy, Pittsburgh, PA (US)

(21) Appl. No.: 18/373,544

(22) Filed: Sep. 27, 2023

Related U.S. Application Data
(60) Provisional application No. 63/410,355, filed on Sep. 27, 2022.

(51) Int. Cl. G06F 9/50

(52) U.S. Cl. CPC G06F 9/5027

(57) ABSTRACT

Provided are a resource management system and method, which can be implemented in the context of autonomously navigating vehicles, such as autonomous mobile robots (AMRs). A route and a graph network are provided, wherein the graph network comprises interconnected nodes representing resources in an environment. The resources include shared spaces and non-shared spaces accessible by the vehicle navigating the route. A resource manager module analyzes the route based on the graph network to determine one or more sets of related shared spaces on the route; applies an ordering algorithm to generate a hierarchy associated with each set of related shared spaces; and, for each set of related shared spaces, generates a set of behaviors to be executed by the vehicle to request access to the set of related shared spaces based on the associated hierarchy.

### CROSS REFERENCE TO RELATED APPLICATIONS

The present application claims priority to U.S. Provisional Patent Appl. No. 63/410,355 filed on Sep. 27, 2022, entitled Dynamic, Deadlock-Free Hierarchical Spatial Mutexes Based on a Graph Network, which is incorporated herein by reference in its entirety.

The present application may be related to International Application No. PCT/US23/016556 filed on Mar. 28, 2023, entitled A Hybrid, Context-Aware Localization System For Ground Vehicles; International Application No. PCT/US23/016565 filed on Mar. 28, 2023, entitled Safety Field Switching Based On End Effector Conditions In Vehicles; International Application No. PCT/US23/016608 filed on Mar. 28, 2023, entitled Dense Data Registration From An Actuatable Vehicle Mounted Sensor; International Application No. PCT/US23,016589, filed on Mar. 28, 2023, entitled Extrinsic Calibration Of A Vehicle-Mounted Sensor Using Natural Vehicle Features; International Application No. PCT/US23/016615, filed on Mar. 28, 2023, entitled Continuous And Discrete Estimation Of Payload Engagement/Disengagement Sensing; International Application No. PCT/US23/016617, filed on Mar. 28, 2023, entitled Passively Actuated Sensor System; International Application No. PCT/US23/016643, filed on Mar. 28, 2023, entitled Automated Identification Of Potential Obstructions In A Targeted Drop Zone; International Application No. PCT/US23/016641, filed on Mar. 28, 2023, entitled Localization of Horizontal Infrastructure Using Point Clouds; International Application No. PCT/US23/016591, filed on Mar. 28, 2023, entitled Robotic Vehicle Navigation With Dynamic Path Adjusting; International Application No. PCT/US23/016612, filed on Mar. 28, 2023, entitled Segmentation of Detected Objects Into Obstructions and Allowed Objects; International Application No. PCT/US23/016554, filed on Mar. 28, 2023, entitled Validating the Pose of a Robotic Vehicle That Allows It To Interact With An Object On Fixed Infrastructure; and International Application No. PCT/US23/016551, filed on Mar. 28, 2023, entitled A System for AMRs That Leverages Priors When Localizing and Manipulating Industrial Infrastructure; International Application No.: PCT/US23/024114, filed on Jun. 1, 2023, entitled System and Method for Generating Complex Runtime Path Networks from Incomplete Demonstration of Trained Activities; International Application No.: PCT/US23/023699, filed on May 26, 2023, entitled System and Method for Performing Interactions with Physical Objects Based on Fusion of Multiple Sensors; International Application No.: PCT/US23/024411, filed on Jun. 5, 2023, entitled Lane Grid Setup for Autonomous Mobile Robots (AMRs); U.S. Provisional Appl. 63/423,679, filed Nov. 8, 2022, entitled System and Method for Definition of a Zone of Dynamic Behavior with a Continuum of Possible Actions and Structural Locations within Same; U.S. Provisional Appl. 63/423,683, filed Nov. 8, 2022, entitled System and Method for Optimized Traffic Flow Through Intersections with Conditional Convoying Based on Path Network Analysis; U.S. Provisional Appl. 63/423,538, filed Nov. 8, 2022, entitled Method for Calibrating Planar Light-Curtain; U.S. Provisional Appl. 63/430,184 filed on Dec. 5, 2022, entitled Just in Time Destination Definition and Route Planning; U.S. Provisional Appl. 63/430,190 filed on Dec. 5, 2022, entitled Configuring a System that Handles Uncertainty with Human and Logic Collaboration in a Material Flow Automation Solution; U.S. Provisional Appl. 63/430,182 filed on Dec. 5, 2022, entitled Composable Patterns of Material Flow Logic for the Automation of Movement; U.S. Provisional Appl. 63/430,174 filed on Dec. 5, 2022, entitled Process Centric User Configurable Step Framework for Composing Material Flow Automation; U.S. Provisional Appl. 63/430,195 filed on Dec. 5, 2022, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; U.S. Provisional Appl. 63/430,180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and U.S. Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. patent application Ser. No. 11/350,195, filed on Feb. 8, 2006, U.S. Pat. No. 7,466,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; U.S. Design patent application Ser. No. 29/398,127, filed on Jul. 26, 2011, U.S. Pat. No. D680,142, Issued on Apr. 16, 2013, entitled Multi-Camera Head; U.S. Design patent application Ser. No. 29/471,328, filed on Oct. 30, 2013, U.S. Pat. No. D730,847, Issued on Jun. 2, 2015, entitled Vehicle Interface Module; U.S. patent application Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 17/712,660, filed on Apr. 4, 2022, US Publication Number 2022/0297734, Published on Sep. 22, 2022, entitled Laterally Operating Payload Handling Device; U.S. patent application Ser. No. 16/892,549, filed on Jun. 4, 2020, U.S. Pat. No. 11,693,403, Issued on Jul. 4, 2023, entitled Dynamic Allocation And Coordination of Auto-Navigating Vehicles and Selectors; U.S. patent application Ser. No. 18/199,052, filed on May 18, 2023, Publication Number ______, Published on ______, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method; U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022/0100195, Published on Mar. 31, 2022, entitled Vehicle Object-Engagement Scanning System And Method; U.S. patent application Ser. No. 17/478,338, filed on Sep. 17, 2021, US Publication Number 2022/0088980, Published on Mar. 24, 2022, entitled Mechanically Adaptable Hitch Guide; U.S. patent application Ser. No. 29/832,212, filed on Mar. 25, 2022, entitled Mobile Robot, each of which is incorporated herein by reference in its entirety.

### FIELD OF INTEREST

The present inventive concepts relate to the field of robotics and autonomous mobile robots (AMRs). In particular, the inventive concepts may be related to systems and methods in the field of coordinating mobile robots with respect to shared spaces, which can be implemented by or in an AMR.

### BACKGROUND

In some instances, multiple mobile robots, e.g., autonomous mobile robots (AMRs), share access to a collection of nearby physical spaces and must manage access to those spaces in a way that avoids collisions and deadlocks. In some cases, multiple AMRs navigate their own route within an environment and conduct tasks along their respective routes. The routes and behaviors, including navigation behaviors and tasks, are typically loaded onto an AMR and then the AMR navigates the route and executes the tasks. In a warehouse environment, as an example, AMRs might navigate around a warehouse picking and dropping loads or performing other assigned tasks.

In navigating a routes, AMRs often encounter shared physical spaces, e.g., physical spaces that can be accessed by different AMRs. A request for usage of a shared space is typically not made until immediately before access to the space is required. The request is wirelessly transmitted to a supervisor system (or supervisor), which could also act as or be referred to as a fleet management system or warehouse system. The supervisor is a computer system capable of monitoring the AMRs and selectively granting or denying access to shared spaces throughout the environment. Ideally, the AMRs and the supervisor collaborate to manage access to shared physical spaces in a way that optimizes throughput with respect to those shared physical spaces. However, in some scenarios assignment of nearby shared spaces to different AMRs can lead to deadlocks.

It would be advantageous to provide a system and method that enables more efficient use of shared spaces by AMRs that avoids deadlocks. It would be further advantageous to apply such systems and methods not only to warehouse environments and warehouse AMRs, but to other environments where other types of autonomously navigating vehicles access shared spaces. It may further be advantageous to provide effective, automated resource management for other types of shared resources, e.g., staging areas, parking areas, refueling and recharging areas, maintenance areas, as examples.

### SUMMARY

In accordance with various aspects of the inventive concepts, provide is a resource management system, comprising: at least one processor in communication with at least one computer storage device comprising computer program code executable by the at least one processor; a route and a graph network stored in the at least one computer storage device, the graph network comprising interconnected nodes representing resources in an environment, the resources including shared spaces and non-shared spaces accessible by an autonomously navigating vehicle configured to execute the route; and a resource manager module. The resource manager module configured to: analyze the route based on the graph network to determine one or more sets of related shared spaces on the route; apply an ordering algorithm to generate a hierarchy associated with each set of related shared spaces; and for each set of related shared spaces, generate a set of behaviors to be executed by the vehicle to request access to the set of related shared spaces based on the associated hierarchy.

In accordance with various aspects of the inventive concepts, the vehicle is an autonomous mobile robot (AMR).

In accordance with various aspects of the inventive concepts, the AMR is an autonomously navigating pallet truck or tugger.

In accordance with various aspects of the inventive concepts, the resource manager module is configured to generate the hierarchy associated with each set of related shared spaces prior to the vehicle navigating the route.

In accordance with various aspects of the inventive concepts, the non-shared spaces and the shared spaces include physical spaces.

In accordance with various aspects of the inventive concepts, the resource manager module is on-board the vehicle.

In accordance with various aspects of the inventive concepts, at least a portion of the resource manager module is offboard the vehicle.

In accordance with various aspects of the inventive concepts, the ordering algorithm is a global ordering algorithm applied by a plurality of autonomously navigating vehicles within the environment.

In accordance with various aspects of the inventive concepts, the resource manager module is configured to add markers to the route, the markers indicating locations of the sets of related shared spaces on the route.

In accordance with various aspects of the inventive concepts, the resource manager module is configured to automatically add the markers to the route.

In accordance with various aspects of the inventive concepts, the resource manager module is configured to add the markers to the route in response to user inputs via a user interface.

In accordance with various aspects of the inventive concepts, each marker is a queue usable by the resource manager module to instruct the vehicle to execute a set of behaviors associated with a set of related shared spaces associated with the marker.

In accordance with various aspects of the inventive concepts, a set of behaviors associated with a set of related shared spaces is usable by the vehicle to iteratively request access to each shared space from the set of related shared spaces based on the hierarchy.

In accordance with various aspects of the inventive concepts, a set of behaviors associated with a set of related shared spaces is usable by the vehicle to request access to a plurality of shared spaces from the set of related shared spaces based on the hierarchy.

In accordance with various aspects of the inventive concepts, a set of behaviors associated with a set of related shared spaces is usable by the vehicle to request access to all shared spaces in the set of related shared spaces at one time.

In accordance with various aspects of the inventive concepts, wherein the resource manager module is configured to maintain a grant of access to more than one shared space from the set of related shared spaces at the same time.

In accordance with various aspects of the inventive concepts, the resource manager module is configured to maintain a grant of access to all of the shared spaces from the set of related shared spaces at the same time.

In accordance with various aspects of the inventive concepts, the resource manager module is configured to relinquish a grant of access to all of the shared spaces from the set of related shared spaces once the vehicle has completed navigation of the set of related shared spaces.

In accordance with another aspect of the inventive concepts, provided is an autonomous mobile robot comprising the resource management system as described above.

In accordance with another aspect of the inventive concepts, provided is a resource management method, comprising: providing at least one processor in communication with at least one computer storage device comprising computer program code executable by the at least one processor; providing a route and a graph network stored in the at least one computer storage device, the graph network comprising interconnected nodes representing resources in an environment, the resources including shared spaces and non-shared spaces accessible by an autonomously navigating vehicle configured to execute the route; and providing a resource manager module. The resource manager module performs at least the following: determining one or more sets of related shared spaces on the route by analyzing the route based on the graph network; generating a hierarchy associated with each set of related shared spaces by applying an ordering algorithm; and for each set of related shared spaces, generating a set of behaviors to be executed by the vehicle to request access to the set of related shared spaces based on the associated hierarchy.

In accordance with various aspects of the inventive concepts, the vehicle is an autonomous mobile robot (AMR).

In accordance with various aspects of the inventive concepts, the AMR is an autonomously navigating pallet truck or tugger.

In accordance with various aspects of the inventive concepts, the method further comprises the resource manager generating the hierarchy associated with each set of related shared spaces prior to the vehicle navigating the route.

In accordance with various aspects of the inventive concepts, the non-shared spaces and the shared spaces include physical spaces.

In accordance with various aspects of the inventive concepts, the resource manager module is on-board the vehicle.

In accordance with various aspects of the inventive concepts, at least a portion of the resource manager module is offboard the vehicle.

In accordance with various aspects of the inventive concepts, the ordering algorithm is a global ordering algorithm applied by a plurality of autonomously navigating vehicles within the environment.

In accordance with various aspects of the inventive concepts, the method further comprises the resource manager module adding markers to the route, the markers indicating locations of the sets of related shared spaces on the route.

In accordance with various aspects of the inventive concepts, the method further comprises the resource manager module automatically adding the markers to the route.

In accordance with various aspects of the inventive concepts, the method further comprises the resource manager module adding the markers to the route in response to user inputs via a user interface.

In accordance with various aspects of the inventive concepts, the method further comprises the resource manager module using each marker as a queue to instruct the vehicle to execute a set of behaviors associated with a set of related shared spaces associated with the marker.

In accordance with various aspects of the inventive concepts, the method further comprises the resource manager module instructing the vehicle to execute a set of behaviors associated with a set of related shared spaces to iteratively request access to each shared space from the set of related shared spaces based on the hierarchy.

In accordance with various aspects of the inventive concepts, the method further comprises the resource manager module instructing the vehicle to execute a set of behaviors associated with a set of related shared spaces to request access to a plurality of shared spaces from the set of related shared spaces based on the hierarchy.

In accordance with various aspects of the inventive concepts, the method further comprises the resource manager module instructing the vehicle to execute a set of behaviors associated with a set of related shared spaces to request access to all shared spaces in the set of related shared spaces at one time.

In accordance with various aspects of the inventive concepts, the method further comprises the resource manager module maintaining a grant of access to more than one shared space from the set of related shared spaces at the same time.

In accordance with various aspects of the inventive concepts, the method further comprises the resource manager module maintaining a grant of access to all of the shared spaces from the set of related shared spaces at the same time.

In accordance with various aspects of the inventive concepts, the method further comprises the resource manager module relinquishing a grant of access to all of the shared spaces from the set of related shared spaces once the vehicle has completed navigation of the set of related shared spaces.

In accordance with another aspect of the inventive concepts, provided is an autonomously navigating vehicle system, comprising: at least one processor in communication with at least one computer storage device comprising computer program code executable by the at least one processor; a navigation system operatively coupled to a drive system; a communication system configured to wirelessly communicate with an external supervisor system; a route and a graph network stored in the at least one computer storage device, the graph network comprising interconnected nodes representing resources in an environment, the resources including shared spaces and non-shared spaces accessible by an autonomously navigating vehicle configured to execute the route; and a resource manager module. The resource manager module is configured to: analyze the route based on the graph network to determine one or more sets of related shared spaces on the route; apply an ordering algorithm to generate a hierarchy associated with each set of related shared spaces; and for each set of related shared spaces, generate a set of behaviors to be executed by the vehicle to request access to the set of related shared spaces based on the associated hierarchy.

In accordance with various aspects of the inventive concepts, the vehicle is an autonomous mobile robot (AMR).

In accordance with various aspects of the inventive concepts, the AMR is an autonomously navigating pallet truck or tugger.

In accordance with various aspects of the inventive concepts, the resource manager module is configured to generate the hierarchy associated with each set of related shared spaces prior to the vehicle navigating the route.

In accordance with various aspects of the inventive concepts, the non-shared spaces and the shared spaces include physical spaces.

In accordance with various aspects of the inventive concepts, the resource manager module is on-board the vehicle.

In accordance with various aspects of the inventive concepts, at least a portion of the resource manager module is offboard the vehicle.

In accordance with various aspects of the inventive concepts, the ordering algorithm is a global ordering algorithm applied by a plurality of autonomously navigating vehicles within the environment.

In accordance with various aspects of the inventive concepts, the resource manager module is configured to add markers to the route, the markers indicating locations of the sets of related shared spaces on the route.

In accordance with various aspects of the inventive concepts, the resource manager module is configured to automatically add the markers to the route.

In accordance with various aspects of the inventive concepts, the resource manager module is configured to add the markers to the route in response to user inputs via a user interface.

In accordance with various aspects of the inventive concepts, each marker is a queue usable by the resource manager module to instruct the vehicle to execute a set of behaviors associated with a set of related shared spaces associated with the marker.

In accordance with various aspects of the inventive concepts, a set of behaviors associated with a set of related shared spaces is usable by the vehicle to iteratively request access to each shared space from the set of related shared spaces based on the hierarchy.

In accordance with various aspects of the inventive concepts, a set of behaviors associated with a set of related shared spaces is usable by the vehicle to request access to a plurality of shared spaces from the set of related shared spaces based on the hierarchy.

In accordance with various aspects of the inventive concepts, a set of behaviors associated with a set of related shared spaces is usable by the vehicle to request access to all shared spaces in the set of related shared spaces at one time.

In accordance with various aspects of the inventive concepts, the resource manager module is configured to maintain a grant of access to more than one shared space from the set of related shared spaces at the same time.

In accordance with various aspects of the inventive concepts, the resource manager module is configured to maintain a grant of access to all of the shared spaces from the set of related shared spaces at the same time.

In accordance with various aspects of the inventive concepts, the resource manager module is configured to relinquish a grant of access to all of the shared spaces from the set of related shared spaces once the vehicle has completed navigation of the set of related shared spaces.

In accordance with another aspect of the inventive concepts, provided is computer-readable medium on which instructions are encoded for carrying out a resource management process. The process comprises: determining one or more sets of related shared spaces on a route by analyzing the route based on a graph network, the graph network comprising interconnected nodes representing resources in an environment, the resources including shared spaces and non-shared spaces accessible by an autonomously navigating vehicle configured to execute the route; generating a hierarchy associated with each set of related shared spaces by applying an ordering algorithm; and for each set of related shared spaces, generating a set of behaviors to be executed by the vehicle to request access to the set of related shared spaces based on the associated hierarchy.

In various embodiments, the vehicle is an autonomous mobile robot (AMR).

In various embodiments, the AMR is an autonomously navigating pallet truck or tugger.

In various embodiments, process further comprising generating the hierarchy associated with each set of related shared spaces prior to the vehicle navigating the route.

In various embodiments, the non-shared spaces and the shared spaces include physical spaces.

In various embodiments, the computer-readable medium is on-board the vehicle.

In various embodiments, at least a portion of the computer-readable medium is offboard the vehicle.

In various embodiments, the ordering algorithm is a global ordering algorithm applied by a plurality of autonomously navigating vehicles within the environment.

In various embodiments, the process further comprising adding markers to the route, the markers indicating locations of the sets of related shared spaces on the route.

In various embodiments, the process further comprising automatically adding the markers to the route.

In various embodiments, the process further comprising adding the markers to the route in response to user inputs via a user interface.

In various embodiments, the process further comprising using each marker as a queue to instruct the vehicle to execute a set of behaviors associated with a set of related shared spaces associated with the marker.

In various embodiments, the process further comprising instructing the vehicle to execute a set of behaviors associated with a set of related shared spaces to iteratively request access to each shared space from the set of related shared spaces based on the hierarchy.

In various embodiments, the process further comprising instructing the vehicle to execute a set of behaviors associated with a set of related shared spaces to request access to a plurality of shared spaces from the set of related shared spaces based on the hierarchy.

In various embodiments, the process further comprising instructing the vehicle to execute a set of behaviors associated with a set of related shared spaces to request access to all shared spaces in the set of related shared spaces at one time.

In various embodiments, the process further comprising maintaining a grant of access to more than one shared space from the set of related shared spaces at the same time.

In various embodiments, the process further comprising maintaining a grant of access to all of the shared spaces from the set of related shared spaces at the same time.

In various embodiments, the process further comprising relinquishing a grant of access to all of the shared spaces from the set of related shared spaces once the vehicle has completed navigation of the set of related shared spaces.

As will be understood by one skilled in the art, two or more of the various system features described above can be combined in a variety of ways without departing from the inventive concepts. Similarly, the two or more of the various method features described above can be combined in a variety of ways without departing from the inventive concepts. Similarly, the two or more of the various computer-readable medium features described above can be combined in a variety of ways without departing from the inventive concepts.

### BRIEF DESCRIPTION OF THE DRAWINGS

The present inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 illustrates an example graph network describing how an AMR can utilize a shared space, in accordance with aspects of inventive concepts.

FIG. 2A is a perspective view of an embodiment of an AMR forklift, in accordance with aspects of the inventive concepts.

FIG. 2B is a block diagram of a shared resource manager system, in accordance with aspects of inventive concepts.

FIG. 3 is a flowchart of a method shared resource management, in accordance with aspects of inventive concepts.

FIGS. 4A-4D show two AMRs interacting using prior art approaches, which may result in the AMRs being deadlocked.

FIGS. 5A-5E show an example of two AMRs interacting in accordance with aspects of inventive concepts.

FIGS. 6A-6C show two AMRs interacting, in accordance with aspects of inventive concepts.

### DETAILED DESCRIPTION OF PREFERRED EMBODIMENTS

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

In accordance with aspects of the inventive concepts, a system and method are provided that enable multiple agents to access shared resources in an orderly manner that avoids deadlocks, contention, and/or reduces congestion, as well as increasing throughput with respect to the shared resources.

In various embodiments, the agent can be one or more autonomously navigating vehicles, which can be or include one or more autonomous mobile robots (AMRs), and the shared resources can be shared physical spaces that can be accessed by a plurality of different AMRs, at different times, while executing routes through an environment. In various embodiments, shared resources could be charging stations, parking spaces, staging lanes, or intersections, as examples. In such contexts, the inventive concepts can be usefully applied in lane staging applications, where lanes can be a type of shared space that can be used for staging goods to be transported by the AMRs. More generally, in the context of the inventive concepts, shared spaces may also be referred to as “intersections,” where an intersection is a place where vehicle paths intersect. More particularly, in various embodiments, the intersection is a physical space that can only be occupied by a single vehicle at a time. Therefore, for purposes of this disclosure, lanes can be implemented by using multiple intersections, one for each shared space.

In environments that use lane staging, such as, for example, warehouse environments, improved throughput will be achieved by mitigating congestion, contention issues, and deadlocks associated with multiple AMRs attempting access of the same or nearby shared spaces at the same time, which can be referred to as a set of related shared spaces. Nearby shared spaces can be adjacent shared spaces where an AMR would travel from a first shared space directly to an adjacent second (nearby) shared space. The inventive concepts are not inherently limited to warehouse environments or lane staging or intersection contexts, as will be appreciated by those skilled in the art.

As mentioned above, shared spaces may be physical spaces sought for use by more than one AMR. A plurality of shared spaces may define a larger area or navigable feature, such as an intersection or a lane staging area, where only one AMR can occupy a single shared space at a time. In accordance with aspects of the inventive concepts, a plurality of shared spaces within the larger area could be accessed by different AMRs at the same time. Each shared space within a larger area could be individually requested by an AMR and assignable to the AMR by a supervisor system (or “supervisor”) in communication with a plurality of AMRs.

In accordance with aspects of the inventive concepts, an AMR may include executable logic and processing capability necessary to request access to a shared space or group of related shared spaces, either being a set of related shared spaces, from the supervisor system. The supervisor can be configured to enable and/or grant an AMR's exclusive temporal access to a set of related shared spaces, without conflict or contention with another AMR. This exclusive access to the set of related shared spaces may be granted in response to the request made by or on behalf of the AMR in communication with a supervisor overseeing the set of related shared spaces, e.g., related shared spaces within a larger area. That is, the AMR may determine that it is near a set of related shared spaces and, based on a hierarchy associated with the set of related shared spaces, send a request for use of a shared space to the supervisor and the supervisor may assign the shared space to the AMR in response to the request. The supervisor may also be configured to deny the AMR access to a shared space, particularly if access to the shared space has been assigned to another AMR.

In various embodiments, a resource manager system can form part of (onboard) or be in communication with (offboard) the AMR and be configured to analyze a route to be navigated by the AMR using a graph network that represents locations, including shared and non-shared spaces, as a set of connected nodes and to apply a global ordering algorithm to generate a hierarchy for each set of related shared spaces on the route. A graph network can comprise a plurality of nodes connected by branches or edges, where each node can represent a different physical shared or non-shared space and edges can define relationships or behaviors associated with the nodes. In various embodiments, shared spaces may be spaces used to pick and/or drop loads, spaces with equipment, such as charging stations, or spaces having any other types of shared resources or equipment. A plurality of AMRs within the environment can apply the same global ordering algorithm for the generation of hierarchies associated with shared spaces to be navigated on their routes. Applying a global ordering algorithm ensures that the AMRs contending for the same shared spaces generate and use hierarchies that avoid deadlocks.

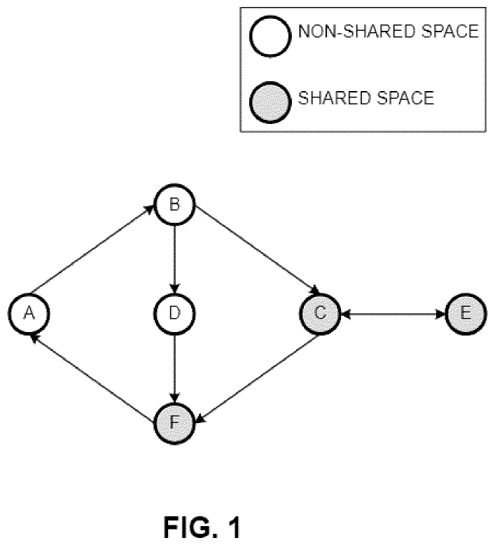

FIG. 1 illustrates an example graph network of an environment. The graph network can represent the pathways and intersections to be travelled within an environment, such as a warehouse, for example. Nodes in the graph network can represent shared and non-shared resources, such as a shared and non-shared physical spaces. In various embodiments, the graph network will be defined for the environment and each AMR will analyze its route against the graph network, such that each route will comprise a plurality of the connected nodes from the graph network. That is, the nodes from the graph network that apply to the AMR will depend on the route the AMR is to navigate through the environment.

As shown in FIG. 1, this example of a graph network, or portion of a graph network, includes interconnected nodes A, B, C, D, E, and F. Nodes A, B, C, D, E and F represent different physical spaces in this embodiment. Connections between the nodes indicate relationships between the nodes. Nodes C, E and F represent shared spaces. Nodes A, B, and D represent non-shared spaces. The arrows or double arrows connecting the nodes indicate behaviors in terms of a permitted direction of travel from one node to another.

In FIG. 1, example relationships between nodes include that node C comes after node B and node E is only accessible via node C. If node E is only accessible via node C, an AMR that needs to access node E must first pass through node C. Therefore, an AMR will need to request access to both nodes C and E in order to access node E. This is a relationship where a deadlock could otherwise occur, without implementation of the inventive concepts. Some relationships between nodes, like this one, may be analyzed by the shape and features of the graph network, while other relationships may require additional information related to how a node can be accessed.

In the embodiment of FIG. 1, for example, based on the relationships between the nodes in the graph network, if an AMR is given a route from node A→node E→node F, the specific sequence that the AMR can travel is node A→node B→node C→node E→node C→node F. This sequence can be determined, at least in part, by the relationships between the nodes. For example, the arrows in FIG. 1 indicate a directionality of the sequence.

In accordance with aspects of the inventive concepts, the resource manager system of the AMR determines the portion of the graph network that is part of its route and determines the sets of related shared spaces included in the portion of the graph network that are on its route. The resource manager system than applies an ordering algorithm to those shared spaces to generate a hierarchy for each set of related shared spaces it will encounter as it navigates its route. In some embodiments, all parts of the system can use the same ordering algorithm so that the algorithm is a global ordering algorithm. In various embodiments, the global ordering algorithm is a sorting algorithm that puts shared spaces in order when generating hierarchies related to sets of shared spaces. For example, in some embodiments, the order may be a lexicographic (or alphabetical) order. In other embodiments, the order may be a reverse lexicographic (or reverse alphabetical) order. However, the inventive concepts are not limited thereto. In other embodiments, the global ordering algorithm could use a different order, such as ordering shared spaces by sequence or relationship in the graph network and/or by type, e.g., lane staging, bidirectional, unidirectional, charging station, pass through, first-in-first-out, last-in-last-out, or combinations of two or more thereof or by some other type. Importantly, the benefits of a global ordering algorithm applied across different AMRs to generate hierarchies associated with the same sets of shared spaces avoids deadlocks.

For example, referring to FIG. 1, using the graph network depicted, navigating the set of related shared spaces from node C→node E→node C→node F, a lexicographic global ordering algorithm would generate the following hierarchy for this set of related shared spaces:
1. C
2. E
3. F.
   Note that the hierarchy is not the same as the sequence of navigation, although they could coincidently be the same in some cases.

Referring to FIG. 1, if a reverse lexicographic ordering is used, the hierarchy for this set of related shared spaces is:
1. F
2. E
3. C.

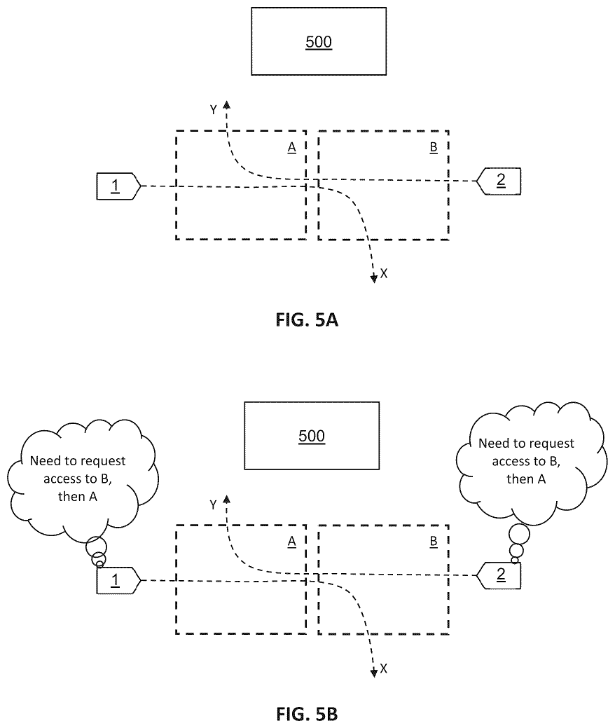

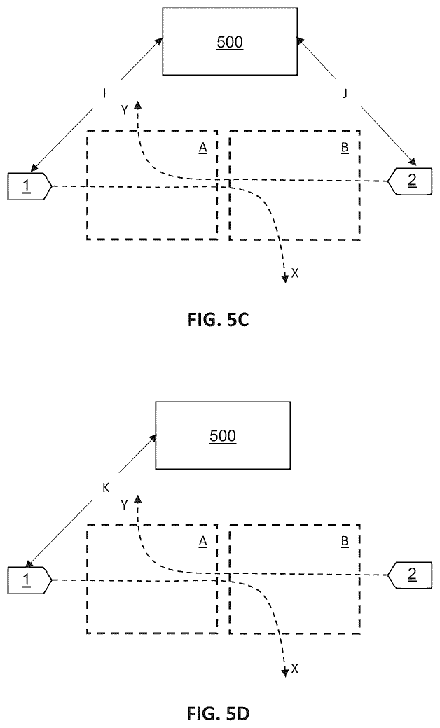

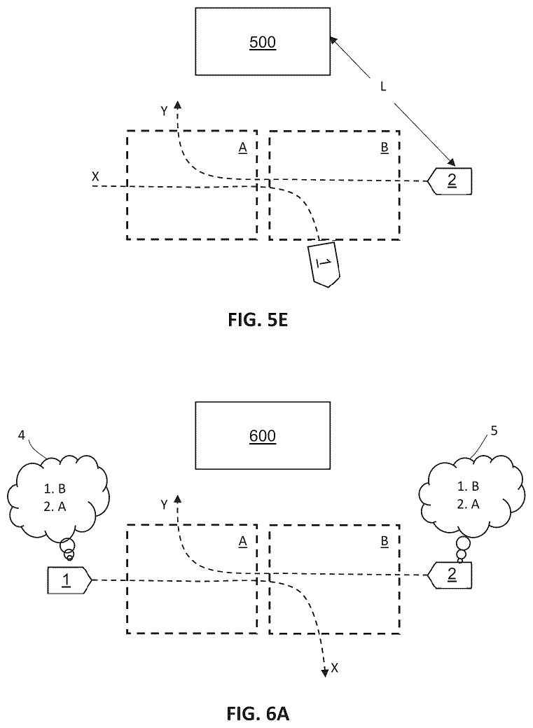

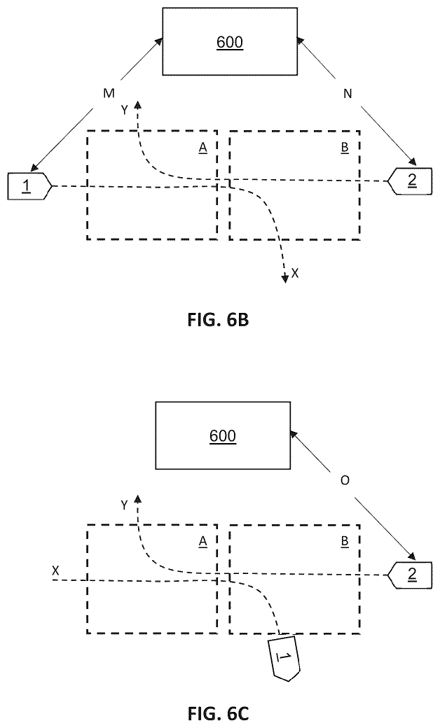

FIGS. 5B and 6A show an example of the global ordering algorithm using reverse lexicographic ordering to produce the following hierarchy for a set of related shared spaces A, B for AMR 1 and AMR 2:
1. B
2. A.

The global algorithm is not limited to lexicographic or reverse lexicographic ordering, as mentioned above. In some embodiments, the algorithm may be more complicated. For instance, the ordering could be that shared spaces that are only connected to shared spaces come first, then sort lexicographically. According to this algorithm, the hierarchy is for the set of related shared spaces from FIG. 1 is:
1. E
2. C
3. F.

With the hierarchy determined for different sets of related shared spaces on its route, the AMR navigates its route. When a set of related shared spaces is encountered, the AMR requests access from a supervisor configured to receive requests for access to shared spaces from AMRs and to selectively grant or deny access to the requested shared spaces. In various embodiments, the supervisor may grant access to a given shared space to only one AMR at a time. The AMR requests access to a shared space, which may be part of a set of related shared spaces, based on the hierarchy determined for the set of related shared spaces. For instance, in some embodiments, if the hierarchy includes three related shared spaces, as a set of related shared spaces, then the AMR will request access to the first space in the hierarchy and once access is granted, request access to the next shared space, and so forth until the AMR is granted access to the final shared space in the hierarchy. Then the AMR will navigate the shared spaces in the sequence defined by its route.

For so long as the AMR occupies the shared space, the shared space is unavailable to other AMRs because the supervisor system will not grant access to the occupied shared space to another AMR while it is occupied. Instead, the supervisor system may deny access to the shared space until it becomes available, in which case the denied AMR may pause and await a grant of access by the supervisor. In some embodiments, the denied AMR request access to a different shared space. Once the AMR has completed its access and/or use of the shared space, the supervisor system can release the shared space for use by another AMR. For example, the supervisor system can assign the now available shared space to another AMR that requested use of the same shared space but was previously denied.

In accordance with aspects of the inventive concepts, a method of shared resource management is provided. The method can be implemented by one or more systems or subsystems described herein used to request access to a set of shared resources, e.g., a set of related shared physical spaces. In various embodiments, the method comprises an AMR analyzing its route and determining the set of shared resources (e.g., a set of related shared physical spaces) to which AMR will need to request and/or require access; the AMR applying a global ordering algorithm to generate a hierarchy associated with each set of related shared spaces on its route based on the graph network or portions of the graph network associated with the route; the AMR navigating the route and, when a set of related shared spaces is determined, the AMR requesting access to at least one shared space from the set of shared spaces from a supervisor based on the generated hierarchy associated with the set of related shared spaces; and the supervisor selectively granting or denying access to one or more requested shared space. In the case of a set of related shared spaces comprising a plurality of shared spaces in a hierarchy, the AMR will iterate through the hierarchy requesting access to the shared spaces in the set of shared spaces, or will request access to a plurality of the related shared spaces or all of the related shared spaces, depending on the embodiment. When access is granted to the final shared space in the hierarchy by the supervisor, the AMR will navigate the set of related shared spaces according to a sequence defined by the route. While access is granted, the supervisor will deny access to other AMRs requesting access to the same shared space or spaces. In some embodiments, access to a shared physical space can be accommodated or given by the supervisor using a first-come-first-served strategy.

In various embodiments, the inventive concepts may be implemented within Palion™ autonomous mobile robots (AMRs) offered by Seegrid Corporation, as one example. In other embodiments, the inventive concepts may be implanted in other AMRs or autonomously navigating or self-navigating vehicles, including any of a variety of mobile robots that may be configured to access shared resources, such as shared physical spaces.

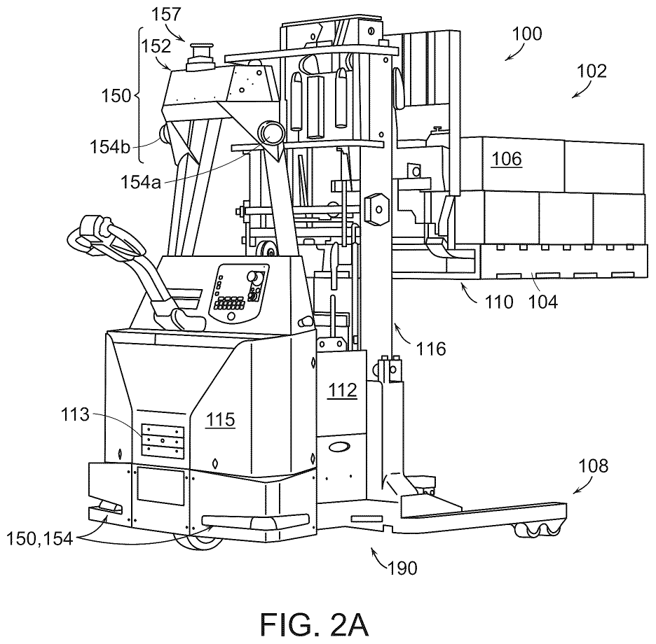

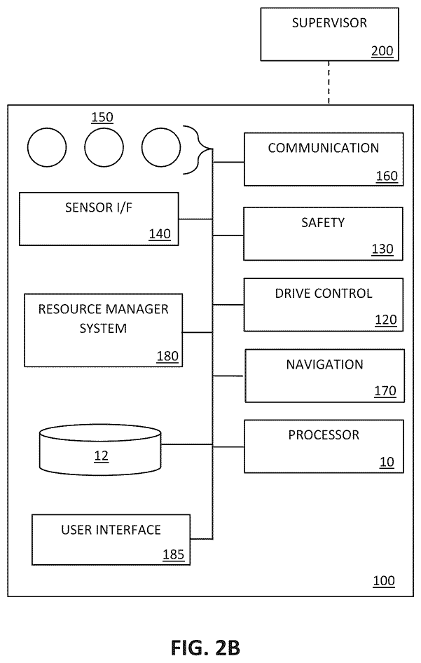

Referring to FIG. 2A, shown is an embodiment of an AMR 100, in accordance with aspects of the inventive concepts. In this embodiment, the AMR 100 takes the form of a pallet lift, but the inventive concepts could be embodied in any of a variety of other types of AMRs, including, but not limited to, pallet trucks, tuggers, and the like. In various embodiments, AMRs described herein can employ Linux, Robot Operating System ROS2, and related libraries, which are commercially available and known in the art. But the inventive concepts are not limited to this operating system. Other operating systems could be used in other embodiments.

In this embodiment, the AMR 100 includes a payload area 102 configured to transport a pallet 104 loaded with goods 106, which collectively form a palletized payload. To engage and carry the pallet 104, the AMR may include a pair of forks 110. The forks 110 may be supported by one or more robotically controlled actuators coupled to a carriage 116 that enable the forks 110 to raise and lower and extend and retract to pick up and drop off loads, e.g., palletized loads. Outriggers 108 extend from a chassis 190 in the direction of the forks to stabilize the vehicle, particularly when carrying the palletized load.

The AMR 100 can comprise a battery area 112 for holding one or more batteries. In various embodiments, the one or more batteries can be configured for charging via a charging interface 113, here located within a main housing 115. Various control elements and subsystems can be disposed within the main housing 115, including those that enable the AMR to process information and navigate from place to place, such as electronics, processors, memory, sensors, safety systems, and drive systems.

The AMR 100 may include a plurality of sensors 150 that provide and/or collect various forms of sensor data that enable the AMR to safely navigate throughout an environment, engage with objects to be transported, and avoid obstructions. In various embodiments, the sensor data from one or more of the sensors 150 can be used for path or route navigation and obstruction detection and avoidance, including avoidance of detected objects, hazards, humans, other AMRs, and/or congestion during navigation.

One or more of the sensors 150 can form part of a two-dimensional (2D) or three-dimensional (3D) high-resolution imaging system used for navigation and/or object detection. In some embodiments, one or more of the sensors can be used to collect sensor data used to represent the environment and objects therein using point clouds to form a 3D evidence grid of the space, each point in the point cloud representing a probability of occupancy of a real-world object at that point in 3D space.

The sensors 150 can include one or more stereo cameras 152 and/or other volumetric sensors, sonar sensors, radars, and/or laser imaging, detection, and ranging (LiDAR) scanners or sensors 154, as examples. The inventive concepts are not limited to particular types of sensors. In various embodiments, sensor data from one or more of the sensors 150, e.g., one or more stereo cameras 152 and/or LiDAR scanners 154, can be used to generate and/or update a 2-dimensional or 3-dimensional model or map of the environment, and sensor data from one or more of the sensors 150 can be used for the determining location of the AMR 100 within the environment relative to the electronic map of the environment.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems can be arranged to provide light curtains, and their operation in vehicular applications, are described, for example, in U.S. Pat. No. 8,169,596, entitled System and Method Using a Multi-Plane Curtain, which is hereby incorporated by reference in its entirety.

In the embodiment shown in FIG. 2A, there are at least two LiDAR devices 154a, 154b positioned at the top of the AMR 100, such as 2D or 3D LiDAR devices. In the embodiment shown in FIG. 2A, there is a sensor 157, for example, a 2D LiDAR, positioned at the top of the AMR 100 that can be used in vehicle localization.

FIG. 2B is a block diagram of components of an embodiment of a system incorporating technology for requesting access to one or more shared spaces, or a set of related shared spaces, for at least one AMR, in accordance with principles of inventive concepts. In the embodiment of FIG. 2B, an AMR, such as the AMR 100 of FIG. 2A, is shown in communication with a supervisor system 200 (or “supervisor”). The supervisor 200 can be local or remote to the environment within which the AMR travels, or some combination of local and remote. The embodiment of FIG. 2B is an example; other embodiments of the AMR 100 can include other components and/or use other terminology.

In various embodiments, the supervisor 200 can be or include a fleet management system, warehouse management system, or other system capable of granting access to shared physical spaces. In various embodiments, the supervisor 200 could be configured to perform, for example, fleet management and monitoring for a plurality of robotic vehicles (e.g., a plurality of AMRs) and, optionally, other assets within the environment.

In various embodiments, the supervisor 200 can be configured to provide instructions and data to the AMR 100 and/or to monitor the navigation and activity of the AMR and, optionally, other AMRs. The supervisor 200 can include hardware, software, firmware, receivers and transmitters that enable communication with the AMR 100 and any other internal or external systems over any now known or hereafter developed communication technology, such as various types of wireless technology including, but not limited to, WiFi, Bluetooth, cellular, global positioning system (GPS), radio frequency (RF), and so on. In various embodiments, the supervisor 200 can monitor the AMR 100 and/or a plurality of AMRs, such as to determine AMR location within an environment, battery status and/or fuel level, and/or other operating, vehicle, performance, and/or load parameters.

As an example, the supervisor 200 could wirelessly communicate a route to the AMR 100 to enable the AMR to navigate within the environment to perform a task or series of tasks, wherein such tasks can include defined behaviors to be performed at one or more locations on the AMR's route. In other embodiments, the AMR 100 could receive the route by a different mechanism, e.g., downloaded through a wired or wireless connection or input at the AMR through a user interface or digital port.

The route can be relative to a map of the environment stored in memory and, optionally, updated from time-to-time, e.g., in real-time, from vehicle sensor data collected in real-time by the AMR 100 and/or other AMRs as they navigate and/or perform tasks. The sensor data can include sensor data collected from one or more of the various sensors 150. As an example, in a warehouse setting, the route could include one or more stops for the picking, the dropping and/or the staging of goods. The route can include a plurality of route segments and navigation from one stop to another can comprise navigating one or more route segments.

In various embodiments, the environment and paths through the environment can be modelled electronically as a graph network comprising a plurality of interconnected nodes. A node can represent a non-shared or shared space in the real-world domain and the interconnections between nodes can represent behaviors. An AMR's route may comprise a plurality of interconnected nodes from the graph network.

As is shown in FIG. 2B, in example embodiments, the AMR 100 includes various functional elements, e.g., computer executable components and/or modules. In various embodiments, one or more of the functional elements or portions thereof can be maintained within or onboard the AMR 100, such as, for example, within the housing 115. Such functional elements can include at least one processor 10 coupled to at least one memory 12 to cooperatively operate the vehicle and execute its functions or tasks. The memory 12 can include computer program instructions, e.g., in the form of a computer program product and/or code executable by the processor 10. The memory 12 can also store various types of data and information. Such data and information can include route data, route segment data, pick data, location data, environmental data, and/or sensor data, as examples, as well as an electronic map of the environment.

In this embodiment, the processor 10 and memory 12 are shown onboard the AMR 100 of FIG. 2A, but external (offboard) processors, memory, and/or computer program code could additionally or alternatively be provided to make up the functional elements. That is, in various embodiments, the processing and computer storage capabilities can be onboard, offboard, or some combination thereof. For example, some processor and/or memory functions could be distributed across the supervisor 200, other vehicles, and/or other systems external to and in communication with the AMR 100.

In various embodiments, the functional elements of the AMR 100 can include a navigation module 170 configured to access environmental data, such as the electronic map, and route information stored in memory 12, as examples. The navigation module 170 can communicate instructions to a drive control subsystem 120 to cause the AMR 100 to navigate its route within the environment. During vehicle travel, the navigation module 170 may receive information from one or more sensors 150, via a sensor interface (UF) 140, to control and adjust the navigation of the robotic vehicle. For example, the sensors 150 may provide 2D and/or 3D sensor data to the navigation module 170 and/or the drive control subsystem 120 in response to sensed objects and/or conditions in the environment to control and/or alter the AMR' s navigation. As examples, the sensors 150 can be configured to collect sensor data related to objects, obstructions, equipment, goods to be picked, hazards, completion of a task, and/or presence of humans and/or other AMRs.

A safety module 130 can be included and also make use of sensor data from one or more of the sensors 150, including LiDAR scanners 154, to interrupt and/or take over control of the drive control subsystem 120 in accordance with applicable safety standard and practices, such as those recommended or dictated by the United States Occupational Safety and Health Administration (OSHA) for certain safety ratings. For example, if safety sensors, e.g., sensors 154, detect objects in the path as a safety hazard, such sensor data can be used to cause the drive control subsystem 120 to stop the AMR to avoid the hazard.

The AMR 100 can include a communication module 160 configured to enable communications with the supervisor 200 and/or any other external systems. The communication module 160 can include hardware, software, firmware, receivers and transmitters that enable communication with the supervisor 200 and any other internal or external systems over any now known or hereafter developed communication technology, such as various types of wireless technology including, but not limited to, WiFi, Bluetooth, cellular, global positioning system (GPS), radio frequency (RF), and so on.

The functional elements of the AMR 100 may also include a user interface (UI) module 185, which may be configured to process human operator inputs received via a user device, e.g., a pick or drop complete input at a stop on the route executed by the AMR. Other human inputs could also be accommodated, such as inputting map, route segments, lane grids, lanes, shared space marker information, and/or configuration information.

The UI module 185 is shown onboard the AMR in FIG. 2B, but in other embodiments it could be offboard or some combination of onboard and offboard. For example, some user interface module 185 functions could be distributed across the supervisor 200, other vehicles, and/or other systems external to the AMR 100, such as a handheld device, kiosk, or other computer. In some embodiments, the UI module 185 can reside on a handheld device that communicates with the AMR 100 and/or the supervisor 200.

The functional elements of the AMR 100 can further include a resource manager system or module 180 (“the resource manager”) that can include executable computer program code stored in at least one computer storage medium 12 and executable by at least one processor 10 to communicate with the supervisor 200 to request access to a set of related shared spaces, e.g., a shared space or plurality of related shared spaces.

In some embodiments, the resource manager 180 can be used to annotate the route with markers to define a beginning and/or an end of a set of related shared spaces. The resource manager can do this automatically by analyzing the graph network or portions of the graph network associated with the route and/or in response to user input though the UI 185. The markers can be electronic annotations on or associated with the electronic version of the route. The AMR can use the markers to invoke a hierarchy (and/or other behaviors) associated with the set of related shared spaces. When a beginning marker is detected, the AMR executes the associated behaviors and when an end marker is detected the AMR returns to normal navigation along the route.

In some embodiments, the resource manager 180 can be configured to process sensor data and/or navigation data to determine that the AMR 100 is approaching a set of related shared spaces and, in response to the determination, generate a request for access to a shared space or plurality of shared spaces from the set of related shared spaces. In various embodiments, the communication module 160 can be configured to communicate the request for a shared physical space to the supervisor 200. The supervisor 200, having knowledge of other AMRs also requesting access to the shared space or plurality of shared spaces in the set of related shared spaces can selectively assign access to one AMR, while withholding and/or denying access to other AMRs requesting access to the same set of related shared spaces. The supervisor can grant access to the shared space on a first-come-first-served basis, in some embodiments. In other embodiments, priority for access can be determined based on other factors, such priority being given to an AMR having a low fuel status, based on schedule considerations, or priority be given by operator designation, as examples.

The AMRs that have be denied access to the set of related shared spaces can be maintained in an idle or paused state until the set of related shared spaces becomes available, or the supervisor can assign one or more of the denied AMRs to other available shares spaces if a subsequent request is received from the AMR for an available shared space. After a shared space or set of related shared spaces is cleared, i.e., the AMR has left the last shared space in the set of related shared spaces, the supervisor 200 may assign access to the set of related shared spaces to another, waiting AMR.

The resource manager 180 can be configured to generate shared space requests in a structured way using the hierarchies generated based on a global ordering algorithm. A key benefit of the resource manager system and method is that the mutexes can be dynamically generated prior to the AMR navigating its route. In some embodiments, a path network of the AMR, e.g., a connected series of path segments to be navigated when executing a preplanned route, is constrained and thus is restricted to specific use cases of the AMRs, e.g., navigating an intersection, staging area, or other area comprising shared physical spaces. The resource manager 180 can take such constraints into account with generating the hierarchies used to request access to a set of related shared spaces.

Unlike prior approaches, in accordance with aspects of the inventive concepts, multiple AMRs may access a larger shared space simultaneously when that shared space is broken into smaller shared spaces for which access can be individually granted in a structured manner that avoids deadlocks, thereby increasing throughput. For example, a large area with a plurality of lanes or paths (e.g., types of shared physical spaces) can be divided into a plurality of individual physical shared spaces, each space being capable of occupancy by a single AMR at a time. Therefore, in accordance with aspects of the inventive concepts, a plurality of AMRs can navigate the larger area at the same time by individually occupying the smaller individual shared spaces without conflict, as assigned by the supervisor 200 in response to requests from the AMRs.

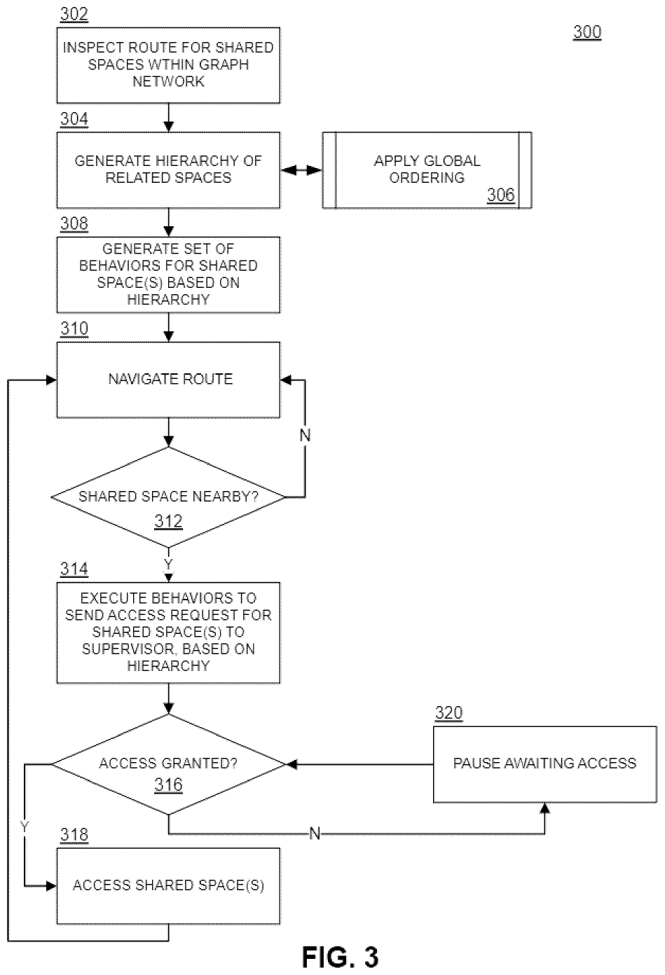

FIG. 3 is a flowchart of an embodiment of a shared resource manager method 300, in accordance with aspects of inventive concepts. The method 300 can be carried out, for example, by the AMR 100. More particularly, the method can be carried out by the resource manager 180, which can be onboard or offboard the AMR. In example embodiments, the resource manager 180 is onboard the AMR. Initially, a route is defined for the AMR to execute (or follow) to perform one or more tasks within an environment, e.g., a warehouse. The route may be stored at the AMR or otherwise accessible by the AMR. The route can be an electronic file received by the AMR and processed to navigate the environment, and/or could be an electronic file built or edited via the UI module 185 of the AMR.

In step 302, resource manager 180 electronically inspects or processes the route to identify sets of related shared spaces within a graph network representing the environment. Through this processing and analysis, the resource manager 180 determines locations of sets of related shared spaces to be navigated along the route. The resource manager 180 may also identify markers on the route that indicate locations of the sets of related shared spaces to be navigated. In some embodiments, the markers can be noted electronically as features of the route. In some embodiments, the resource manager 180 can be configured to process the route to automatically add markers as annotations that define locations of the set of related shared spaces to be encountered on the route. In some embodiments, the resource manager 180 can be configured to process user inputs via UI 185 to add markers as annotations to the route that define locations of the set of related shared spaces to be encountered on the route.

In step 304, for each identified set of related shared spaces, the resource manager system 180 generates a hierarchy of the set of related shared spaces for which access is to be requested, which includes, in step 306, the resource manager system 180 applying a global ordering algorithm, or set of rules, to build each hierarchy for each set of related shared spaces, as discussed above. As discussed with respect to FIG. 1, for instance, if the route is node A→node E→node F, the specific sequence that the AMR will travel is A→B→C→E→C→F and the hierarchy based on a lexicographic global ordering algorithm for the set of related shared spaces C, E, and F will be:
C
E
F.

A reverse lexicographic global ordering algorithm would produce the following hierarchy for the set of related shared spaces:
F
E
C.

In step 308, the resource manager 180 generates a set of behaviors associated with the set of related shared spaces. The behaviors define how the AMR will request access to a set of related shared spaces according to the hierarchy. In some embodiments the behaviors can be invoked and/or executed when a marker on the route is detected and/or when the AMR senses its location using its onboard sensors 150 or other inputs. The information about how to request access to the shared spaces in the set of related shared spaces, such as the order of requesting access to the shared spaces, is stored in the behaviors.

In step 310, the AMR navigates the route. As it navigates, the AMR continues to process sensor data to safely navigate and determine if a set of related shared spaces is detected or sensed along the route, in step 312. If a set of related shared spaces is not detected, in step 312, the AMR continues navigating along its route. If a set of related shared spaces is detected or sensed, the method continues to step 314 where the AMR executes a behavior or behaviors, based on the corresponding hierarchy, associated with the set of related shared spaces to generate one or more requests for access to a shared space or plurality of shared spaces from the set of related shared spaces, which it sends to the supervisor 200.

In step 316, if the requested shared space or spaces are available, the supervisor returns a message to the AMR granting access to the requested shared space or spaces, in step 318. Based on the hierarchy, if there is a plurality of related shared spaces, the resource manager 180 may generate a request for a next shared space in the hierarchy. This continues until the resource manager 180 works through the hierarchy and is iteratively granted access to all of the shared spaces in the set of related shared spaces by the supervisor. Once the hierarchy is completed, the AMR processes the messages and instructs the navigation system 170 to cause the AMR to navigate the set of related shared spaces for which access was granted, following a sequence defined by the route in step 310.

However, if the requested shared space or spaces from the set of shared spaces are not available, in step 316, the supervisor can return a message back to the AMR to pause while awaiting availability of the requested shared space, in step 320. In some embodiments, the AMR may execute a behavior to request a different shared space or spaces, according to the route. In such a case, if the different shared space or spaces are available, the supervisor may grant access to the newly requested shared space or spaces and the AMR can then navigate to the newly requested shared space or spaces.

When the AMR leaves the requested set of related shared spaces, or last space in the navigation sequence from the set of related shared spaces, the set of related shared spaces becomes available for assignment to other AMRs by the supervisor.

By utilizing the hierarchy in the generation of the behaviors, the AMRs can ensure that requests for physical spaces do not cause a deadlock using standard deadlock prevention techniques. Each AMR applies the same hierarchy for the same set of related shared spaces and access can be granted to the first requesting AMR, in some embodiments.

In various embodiments, because the hierarchy is based on a predefined global ordering algorithm, it can be generated at any time for any feasible route and applied by a plurality of AMRs in the environment. The ordering can define a sequence of shared spaces, as a set of related shared spaces, to be assigned to avoid a deadlock. This allows the hierarchy to be generated dynamically at the beginning of a follow behavior (i.e., where the AMR follows a route), and could, in some embodiments, be updated during the follow activity as the AMR autonomously navigates its route.

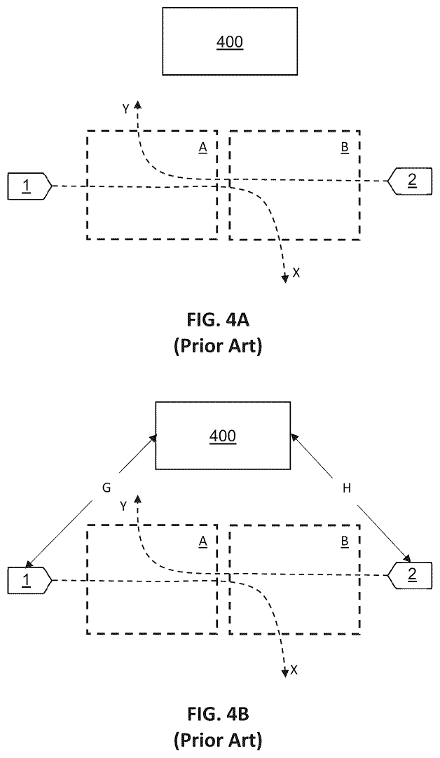

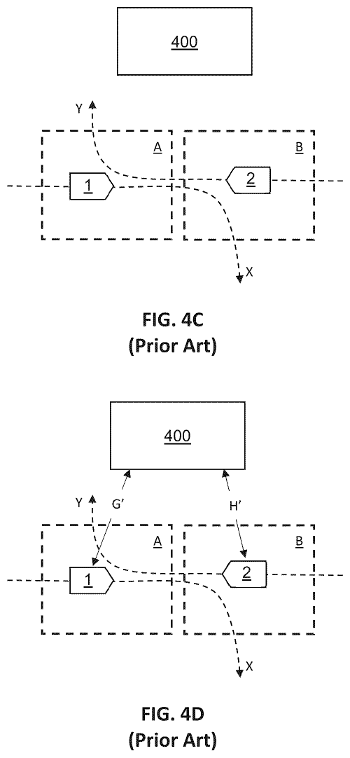

An embodiment of a shared resource manager 180 in accordance with aspects of the inventive concepts implemented for intersection management is described with respect to FIGS. 5A-5E and FIGS. 6A-6C, as compared to prior art approach in FIGS. 4A-4D.

FIGS. 4A-4D show an embodiment of two AMRs 1, 2 interacting using prior art approaches, which may result in the AMRs being deadlocked. In FIG. 4A, a first AMR 1 needs to pass through space A and then through space B along path X to navigate through the shared spaces A and B, which could form a set of related shared spaces of an intersection. A second AMR 2 needs to pass through space B and then through space A along path Y, which could form part of the same intersection navigated in an opposite direction. That is, path X and Y navigate the same physical spaces, but in a different order. Only one AMR may be in a space at a time.

In FIG. 4B, the first AMR 1 requests access to space A from the supervisor 400 via a request G and a supervisor 400 grants such access. The second AMR 2 requests access to space B from the supervisor 400 via a request H and the supervisor 400 grants such access.

FIG. 4C shows the first AMR 1 enters space A and the second AMR 2 enters space B while AMR 1 is in space A.

In FIG. 4D, the first AMR 1 requests access to space B from the supervisor 400 via a request G′, but it is denied because space B is occupied. The second AMR 2 requests access to space A from the supervisor 400 via a request H′, but it is denied because space A is occupied. In this situation, the first AMR 1 and the second AMR 2 are deadlocked because neither may progress to its next space. The resource manager 180 avoids this scenario.

FIGS. 5A-5E show an example of an embodiment of two AMRs 1, 2 interacting with a supervisor 500 in accordance with aspects of inventive concepts. The two AMRs include a resource manager 180, which determines a space access request hierarchy and requests access to the set of related shared spaces in accordance with the hierarchy. In FIG. 5A, a first AMR 1 needs to pass through space A and then through space B along path X. A second AMR 2 needs to pass through space B and then through space A along path Y. In some scenarios, such as this one, only one AMR may be in a space at a time. So far, this is similar to the scenario of FIG. 4A.

In FIG. 5B, both the first AMR 1 and the second AMR 2 use information about the path network and the physical spaces to determine the order in which they should request access to the set of related shared spaces. In FIG. 5B, the global ordering algorithm used reverse lexicographic ordering to produce the following hierarchy for set of related shared spaces A, B for AMR 1:
1. B
2. A.
   And for the same set of related shared spaces to be navigated in the opposite sequence by AMR 2 the hierarchy is the same because the same reverse global ordering algorithm is also used to generate the hierarchy (and behaviors) for AMR 2:
1. B
2. A.

In this example, the first AMR 1 uses behaviors based on the hierarchy associated with this set of related shared spaces to determine that it must first request access to space B, then access to space A. And in this example, the second AMR 2 uses behaviors based on its hierarchy associated with this set of related shared spaces to determine that it must also first request access to space B, then access to space A. Therefore, AMR 1 will request access to space B from the supervisor 500 via request I and AMR 2 will request access to space B from the supervisor 500 via request J. In this embodiment, neither AMR is going to request access to A until the requests for B are sorted out.

In FIG. 5C, therefore, the request I from the first AMR 1 is sent to the supervisor 500 and the request J from the second AMR 2 is sent to the supervisor 500. In this example, the first AMR 1 and the second AMR 2 both requested access to space B. The first request I arrived at the supervisor 500 so is granted, and the second request J arrived later so is denied or delayed. This access grant is communicated to AMR 1 and the access denied is communicated to AMR 2, accordingly. In this embodiment, since request I from AMR 1 arrived first, the supervisor 500 granted the first AMR 1 access to space B, while access to space B by AMR 2 was not granted.

In FIG. 5D, a request K from the first AMR 1 is sent to the supervisor 500 to request access to space A; AMR 1 does not relinquish access to space B while this request is made. The supervisor 500 grants the first AMR 1 access to space A.

Therefore, in this embodiment, the supervisor grants access to AMR 1 for space B first; AMR 1 must then make a separate request for space A. Once that second request is granted, the AMR has access to both shared spaces A, B and can proceed to navigate in its route sequence through A and then B.

In various embodiments, the supervisor does not make any kind of association between space A and B or requests for either. The knowledge of the relationship between the spaces is entirely contained in the AMRs and/or their resource managers 180.

In FIG. 5E, once the first AMR 1 exits space B, the first AMR 1 will relinquish spaces A and B. The second AMR 2 may then request, via request L, access to space B. If granted, the second AMR 2 can then request access to space A, without relinquishing its grant of access to space B. In some embodiments, the supervisor may be configured to automatically grant AMR 2 access to space B with request L or the supervisor may be configured to send AMR 2 a message that space B is available so that AMR 2 can again request access to space B. Once access is to space B and then space A is granted to AMR 2, AMR 2 may proceed to space B and then space A along path Y.

However, if the supervisor 500 received the request J before the request I, the supervisor 500 grants the second AMR 2 access to space B, and access to space B is not granted to AMR 1. The second AMR 2 then requests access to space A, without relinquishing its grant of access to space B. If access to space A is also granted to AMR 2, AMR 2 navigates its route through space B and then space A. Once the second AMR 2 exits space A, the first AMR 1 can request and will be granted access to space B. The first AMR 1 may then request access to space A and, once access is granted, AMR 1 may proceed to space A and then B, as it navigates its path X.

FIGS. 6A-6C show an embodiment of two AMRs interacting with a supervisor 600 in accordance with aspects of inventive concepts. The different AMRs (in this example there are two AMRs 1, 2) determine a space access request hierarchy and request access to the set of related shared spaces in accordance with the hierarchy.

In FIG. 6A, a first AMR 1 needs to pass through space A and then space B along path X. A second AMR 2 needs to pass through space B and then space A along path Y. Only one AMR may be in a space at a time.

In this example, as in the example of FIG. 5B, the global ordering algorithm uses reverse lexicographic ordering to produce the following hierarchy for the set of related shared spaces A, B for AMR 1:
1. B
2. A.
   And for the same set of related shared spaces A, B to be navigated in the opposite sequence by AMR 2 the hierarchy is the same because the same reverse global ordering algorithm is also used to generate the hierarchy (and behaviors) for AMR 2:
1. B
2. A.

Referring to FIG. 6B, the first AMR 1 determines a space access request hierarchy of space B then space A and requests access from the supervisor 600 via request M for access to both spaces in accordance with the hierarchy. The second AMR 2 determines a space access request hierarchy of space B then space A and requests access from the supervisor 600 via request N for access to both spaces in accordance with hierarchy, similar to AMR 1.

In FIG. 6B, the supervisor 600 receives request M first and, in accordance with the hierarchy of the request, the supervisor 600 grants the first AMR 1 access to space B to space A. The supervisor 600 does not grant the second AMR 2 access to space B and space A because they have been granted to AMR 1. Therefore, access is granted to a plurality of shared physical spaces at one time for AMR 1 and access to a plurality of shared physical spaces is denied at one time for AMR 2.

In FIG. 6C, the first AMR 1 proceeds through space A and then space B, it then relinquishes the spaces back to the supervisor. The second AMR 2 can then request and be granted access to space B and space A, via communication O. The second AMR 2 can then navigate the spaces according to its route, and then relinquish the spaces back to the supervisor. In some embodiments, the supervisor 600 could automatically grant access to spaces B and A to AMR 2 once AMR 1 relinquishes them, or supervisor 600 could send a message to AMR 2 soliciting a request for the spaces from AMR 2.

The examples shown in FIGS. 5A-5E and FIGS. 6A-6C illustrate shared resource management for a plurality of AMRs, i.e., a first AMR 1 and a second AMR 2. In alternative embodiments, the systems and methods described herein may comprise one AMR. In alternative embodiments, the systems and methods described herein may comprise more than two AMRs and more than one supervisor. In some embodiments, a plurality of AMRs within an environment can include and/or implement a resource manager, graph network, and global ordering algorithm as described herein.

While the foregoing has described what are considered to be the best mode and/or other preferred embodiments, it is understood that various modifications can be made therein and that aspects of the inventive concepts herein may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provided in combination in a single embodiment. Conversely, various features of the inventive concepts which are, for brevity, described in the context of a single embodiment may also be provided separately or in any suitable sub-combination.

For example, it will be appreciated that all of the features set out in any of the claims (whether independent or dependent) can be combined in any given way.

1. A resource management system, comprising:
at least one processor in communication with at least one computer storage device comprising computer program code executable by the at least one processor;
a route and a graph network stored in the at least one computer storage device, the graph network comprising interconnected nodes representing resources in an environment, the resources including shared spaces and non-shared spaces accessible by an autonomously navigating vehicle configured to execute the route; and
a resource manager module configured to:
analyze the route based on the graph network to determine one or more sets of related shared spaces on the route;
apply an ordering algorithm to generate a hierarchy associated with each set of related shared spaces; and
for each set of related shared spaces, generate a set of behaviors to be executed by the vehicle to request access to the set of related shared spaces based on the associated hierarchy.

2.-19. (canceled)

20. A resource management method, comprising:
providing at least one processor in communication with at least one computer storage device comprising computer program code executable by the at least one processor;
providing a route and a graph network stored in the at least one computer storage device, the graph network comprising interconnected nodes representing resources in an environment, the resources including shared spaces and non-shared spaces accessible by an autonomously navigating vehicle configured to execute the route; and
a resource manager module:
determining one or more sets of related shared spaces on the route by analyzing the route based on the graph network;
generating a hierarchy associated with each set of related shared spaces by applying an ordering algorithm; and
for each set of related shared spaces, generating a set of behaviors to be executed by the vehicle to request access to the set of related shared spaces based on the associated hierarchy.

21. The method of claim 20, wherein the vehicle is an autonomous mobile robot (AMR).

22. The method of claim 21, wherein the AMR is an autonomously navigating pallet truck or tugger.

23. The method of claim 20, further comprising the resource manager generating the hierarchy associated with each set of related shared spaces prior to the vehicle navigating the route.

24. The method of claim 20, wherein the non-shared spaces and the shared spaces include physical spaces.

25. The method of claim 20, wherein the resource manager module is on-board the vehicle.

26. The method of claim 20, wherein at least a portion of the resource manager module is offboard the vehicle.

27. The method of claim 20, wherein the ordering algorithm is a global ordering algorithm applied by a plurality of autonomously navigating vehicles within the environment.

28. (canceled)

29. The method of claim 20, further comprising the resource manager module automatically adding the markers to the route, the markers indicating locations of the sets of related shared spaces on the route.

30. The method of claim 20, further comprising the resource manager module adding the markers to the route in response to user inputs via a user interface, the markers indicating locations of the sets of related shared spaces on the route.

31. The method of claim 28, further comprising the resource manager module using each marker as a queue to instruct the vehicle to execute a set of behaviors associated with a set of related shared spaces associated with the marker.

32. The method of claim 20, further comprising the resource manager module instructing the vehicle to execute a set of behaviors associated with a set of related shared spaces to iteratively request access to each shared space from the set of related shared spaces based on the hierarchy.

33. The method of claim 20, further comprising the resource manager module instructing the vehicle to execute a set of behaviors associated with a set of related shared spaces to request access to a plurality of shared spaces from the set of related shared spaces based on the hierarchy.

34. The method of claim 20, further comprising the resource manager module instructing the vehicle to execute a set of behaviors associated with a set of related shared spaces to request access to all shared spaces in the set of related shared spaces at one time.

35. The method of claim 20, further comprising the resource manager module maintaining a grant of access to more than one shared space from the set of related shared spaces at the same time.

36. The method of claim 20, further comprising the resource manager module maintaining a grant of access to all of the shared spaces from the set of related shared spaces at the same time.

37. The method of claim 20, further comprising the resource manager module relinquishing a grant of access to all of the shared spaces from the set of related shared spaces once the vehicle has completed navigation of the set of related shared spaces.

38. An autonomously navigating vehicle system, comprising:
at least one processor in communication with at least one computer storage device comprising computer program code executable by the at least one processor;
a navigation system operatively coupled to a drive system;
a communication system configured to wirelessly communicate with an external supervisor system;
a route and a graph network stored in the at least one computer storage device, the graph network comprising interconnected nodes representing resources in an environment, the resources including shared spaces and non-shared spaces accessible by an autonomously navigating vehicle configured to execute the route; and
a resource manager module configured to:
analyze the route based on the graph network to determine one or more sets of related shared spaces on the route;
apply an ordering algorithm to generate a hierarchy associated with each set of related shared spaces; and
for each set of related shared spaces, generate a set of behaviors to be executed by the vehicle to request access to the set of related shared spaces based on the associated hierarchy.

39. The system of claim 38, wherein the vehicle is an autonomous mobile robot (AMR).

40. The system of claim 39, wherein the AMR is an autonomously navigating pallet truck or tugger.

41. The system of claim 38, wherein the resource manager module is configured to generate the hierarchy associated with each set of related shared spaces prior to the vehicle navigating the route.

42. The system of claim 38, wherein the non-shared spaces and the shared spaces include physical spaces.

43. The system of claim 38, wherein the resource manager module is on-board the vehicle.

44. The system of claim 38, wherein at least a portion of the resource manager module is offboard the vehicle.

45. The system of claim 38, wherein the ordering algorithm is a global ordering algorithm applied by a plurality of autonomously navigating vehicles within the environment.

46. (canceled)

47. The system of claim 38, wherein the resource manager module is configured to automatically add the markers to the route, the markers indicating locations of the sets of related shared spaces on the route.

48. The system of claim 38, wherein the resource manager module is configured to add the markers to the route in response to user inputs via a user interface, the markers indicating locations of the sets of related shared spaces on the route.

49. The system of claim 46, wherein each marker is a queue usable by the resource manager module to instruct the vehicle to execute a set of behaviors associated with a set of related shared spaces associated with the marker.

50. The system of claim 38, wherein a set of behaviors associated with a set of related shared spaces is usable by the vehicle to iteratively request access to each shared space from the set of related shared spaces based on the hierarchy.

51. The system of claim 38, wherein a set of behaviors associated with a set of related shared spaces is usable by the vehicle to request access to a plurality of shared spaces from the set of related shared spaces based on the hierarchy.

52. The system of claim 38, wherein a set of behaviors associated with a set of related shared spaces is usable by the vehicle to request access to all shared spaces in the set of related shared spaces at one time.

53. The system of claim 38, wherein the resource manager module is configured to maintain a grant of access to more than one shared space from the set of related shared spaces at the same time.

54. The system of claim 38, wherein the resource manager module is configured to maintain a grant of access to all of the shared spaces from the set of related shared spaces at the same time.

55. The system of claim 38, wherein the resource manager module is configured to relinquish a grant of access to all of the shared spaces from the set of related shared spaces once the vehicle has completed navigation of the set of related shared spaces.

56.-73. (canceled)

74.-81. (canceled)
